(19) United States
(12) Patent Application Publication
(10) Pub. No.: US 2019/0019475 A1
(43) Pub. Date: Jan. 17, 2019

(54) SAVING METHOD, SCREEN SAVING SYSTEM AND ELECTRONIC DEVICE USING THE SCREEN SAVING SYSTEM

(71) Applicant: HON HAI PRECISION INDUSTRY CO., LTD., New Taipei (TW)

(72) Inventors: HSUEH-WEN LEE, New Taipei (TW); CHI-HSUN HO, New Taipei (TW); HUI-WEN WANG, New Taipei (TW); YI-TE HSIN, New Taipei (TW); CHUN-YEN KUO, New Taipei (TW)

(21) Appl. No.: 15/695,102

(22) Filed: Sep. 5, 2017

(30) Foreign Application Priority Data
Jul. 13, 2017 (TW) 106123537

(51) Int. Cl. G09G 5/36; G06F 3/0484

(52) U.S. Cl. CPC G09G 5/363; G06F 3/04845; G06F 3/04842

(57) ABSTRACT

A screen saving method, a screen saving system, and electronic devices using the screen saving system enable enhancement of the screen saver experience. The screen saving system includes a storage unit and a processing unit. The processing unit is configured to execute stored instructions to detect a click applied to a moving object on a display device and generate a click request. The validity of the click request is determined, and if valid click, the moving object is made to execute a predetermined function. A screen saving method and electronic device are also disclosed.

### FIELD

The subject matter herein generally relates to a screen saving method, a screen saving system, and electronic devices using the screen saving system.

### BACKGROUND

Utilizing a screen saver program to provide reduced graphics or a blank screen during an idle mode of an electronic device is known. A typical screen saver displays multiple objects generally moving across the display. These objects can be bubbles.

However, the information provided by the screen saver is of very little use to the user of the device.

### BRIEF DESCRIPTION OF THE DRAWINGS

Implementations of the present technology will now be described, by way of example only, with reference to the attached figures.

FIG. 1 is a block diagram of a first exemplary embodiment of an electronic device.

FIG. 2 is a block diagram of a screen saving system in the electronic device of FIG. 1.

FIG. 3 is a block diagram of a screen saving module of a first exemplary embodiment of the screen saving system of FIG. 2.

FIG. 4 is a block diagram of a screen saving module of a second exemplary embodiment of the screen saving system of FIG. 2.

FIG. 5 is a block diagram of a second exemplary embodiment of an electronic device.

FIG. 6 is a block diagram of a third exemplary embodiment of an electronic device.

FIG. 7 is a block diagram of an exemplary embodiment of a screen saving method.

FIG. 8 is a block diagram of a fourth exemplary embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “comprising” means “including, but not necessarily limited to”; it specifically indicates open-ended inclusion or membership in a so-described combination, group, series, and the like.

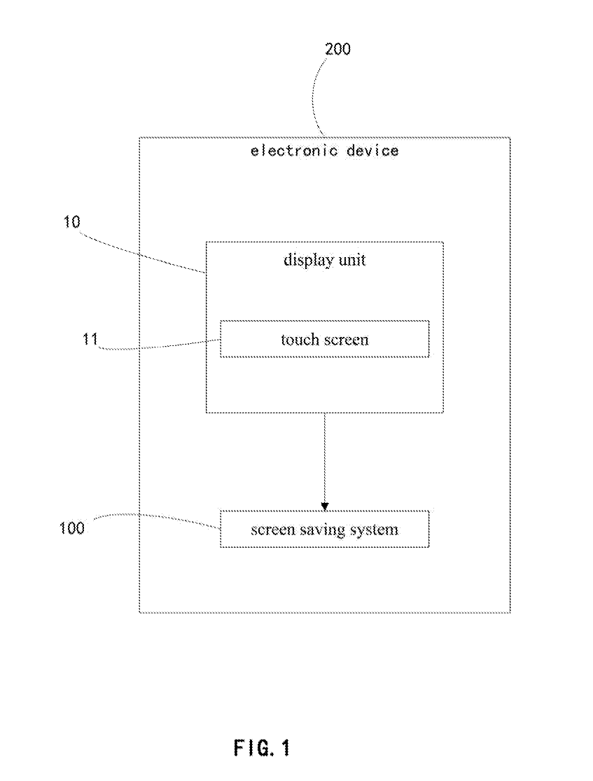

Referring to FIG. 1, an electronic device 200 is illustrated in a first exemplary embodiment, a screen saving system 100 is applied in the electronic device 200. The electronic device 200 can be a tablet computer, a PDA or a mobile phone with a display unit 10, and the display unit includes a touch screen 11. The electronic device 200 can also be Augmented Reality (AR) devices.

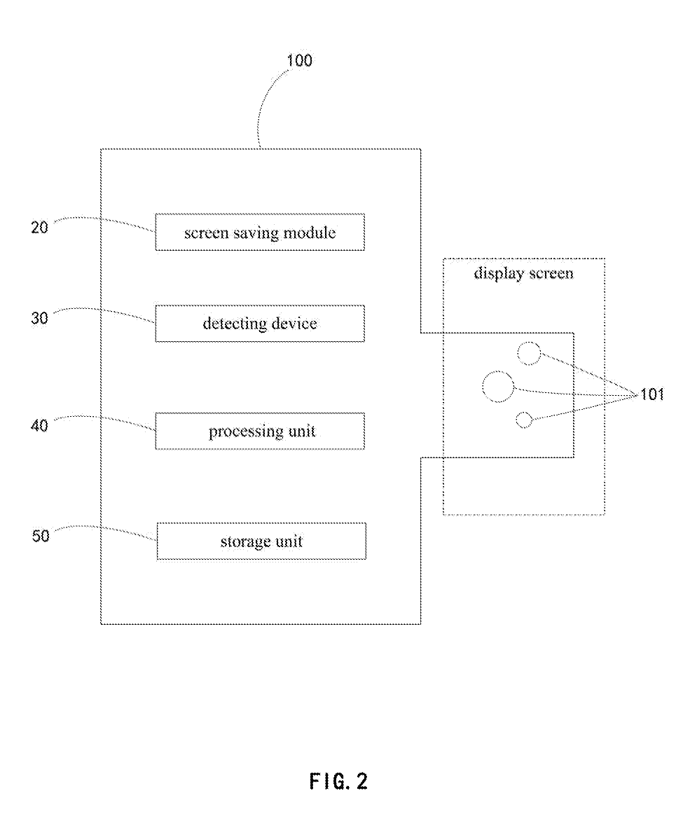

Referring to FIG. 2, the screen saving system 100 can include a screen saving module 20, a detecting device 30, a processing unit 40, and a storage unit 50.

The detecting device 30 can be used to detect a click event applied to the touch screen 11 and generate a click request.

The storage unit 50 is configured to store instructions, and the processing unit 40 is configured to execute the instructions.

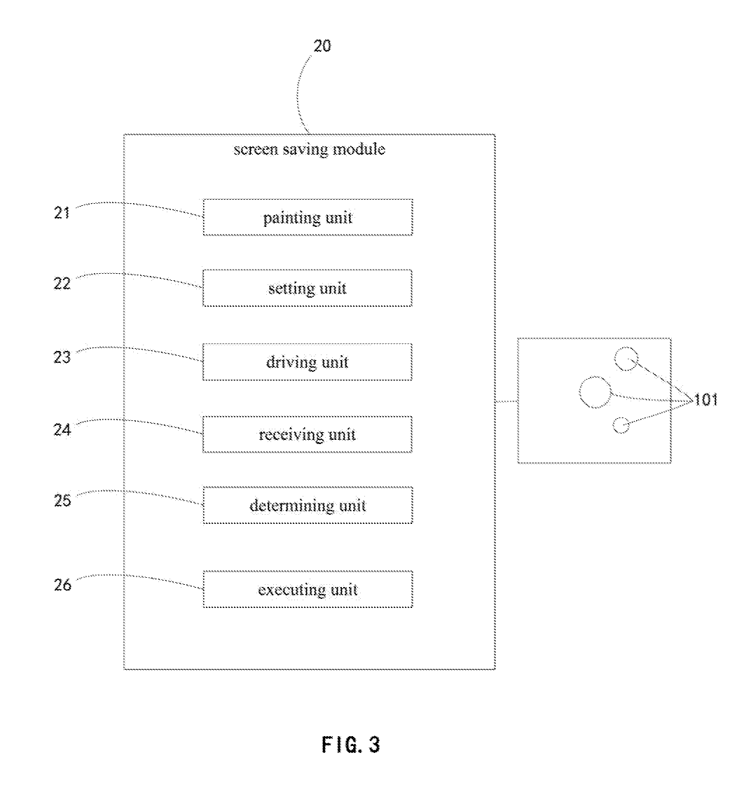

Referring to FIG. 3, the screen saving module 20 is illustrated in a first exemplary embodiment. The screen saving unit 20 can include a painting unit 21, a setting unit 22, a driving unit 23, a receiving unit 24, a determining unit 25, and a executing unit 26.

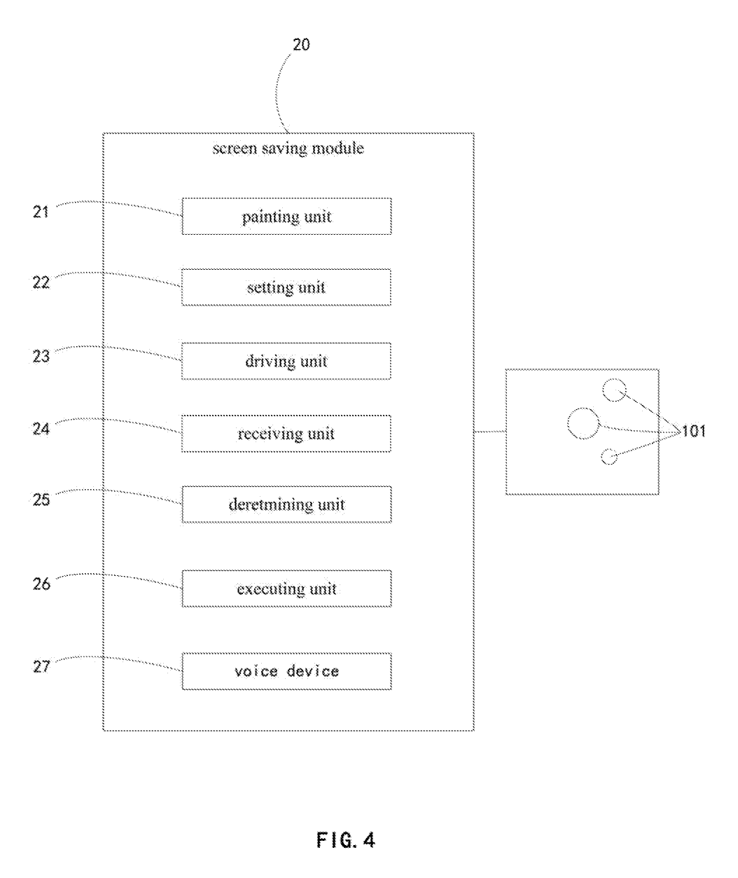

Referring to FIG. 4, the screen saving module 20 is illustrated in a second exemplary embodiment, and the screen saving module 20 can further include a voice device 27.

The painting unit 21 can be used to paint a plurality of moving objects 101. In at least one exemplary embodiment, the moving objects 101 can be bubbles. The moving objects 101 are shown when the screen saving module 20 activates the screen saving system 100.

The painting unit 21 can also be used to paint different colors on the moving objects 101.

The driving unit 23 can be used to drive the moving objects 101 to move. For example, the moving objects 101 can be driven by the driving unit 23 to move randomly. It is understood that the moving objects 101 can also be driven by the driving unit 23 to move regularly according to a pre-determined rule, or to be stationary.

The setting unit 22 can be used to set functions of the moving objects 101.

For example, when the moving objects 101 are painted with colors, each of the moving objects 101 can be endowed with a function that when a moving object meets another moving object with a different color, these two moving objects 101 are combined into one.

In another case, the setting unit 22 can be used to set functions of the moving objects 101 so that when several moving objects 101 contact each other, these moving objects 101 combine with one another and turn into one bigger moving object. For example, three moving objects A, B, and C (A, B, and C are not shown) can come into contact with each other and the moving objects combine with one another and turn into one bigger moving object D (not shown).

In another case, the setting unit 22 can be used to set functions of the moving objects so that when a smaller moving object contacts a bigger moving object, the smaller moving object runs through to interior of the bigger moving object, and the smaller moving object is accommodated in the bigger moving object.

In another case, the setting unit 22 can be used to set functions of the moving objects so that when several moving objects with different colors contact each other, these moving objects combine with one another and turn into one bigger moving object with new color. For example, an RGB value of a moving object (not shown) may be (0,0,255), an RGB value of a another moving object may be (255,0,0). When the moving objects contact each other, they combine with each other and turn into one moving object, having an RGB value of (128,0,128).

The receiving unit 24 can be used to receive the click request generated by the detecting device 30.

The determining unit 25 can be used to determine whether the click request is valid or invalid. For example, the click request can be determined according to the click force and a time duration of a click operation. To be specific, if the click force and the time duration of a click operation are within predetermined ranges, the click operation is deemed valid, otherwise invalid.

When a click operation to a moving object is valid, the executing unit 26 enables the moving object to execute a function set by the setting unit 22. For example, a moving object can be processed by the setting unit 22 such that when the moving object is clicked, a sound will be produced. In such case the voice device 27 would be activated if a click to the moving object is valid.

In another case, when a click operation to a moving object is valid, the moving object can be processed by the setting unit 22 to generate a new object, such as a two-dimensional or three-dimensional (3D) picture.

When the painting unit 21, the setting unit 22, the driving unit 23, the receiving unit 24, the determining unit 25, the executing unit 26 and the voice device 27 are in operation, the screen saving module 20 is in a working state, otherwise the screen saving module 20 is turned off. For example, when the electronic device 200 is woken by a mouse or a keyboard, the screen saving module 20 is turned off.

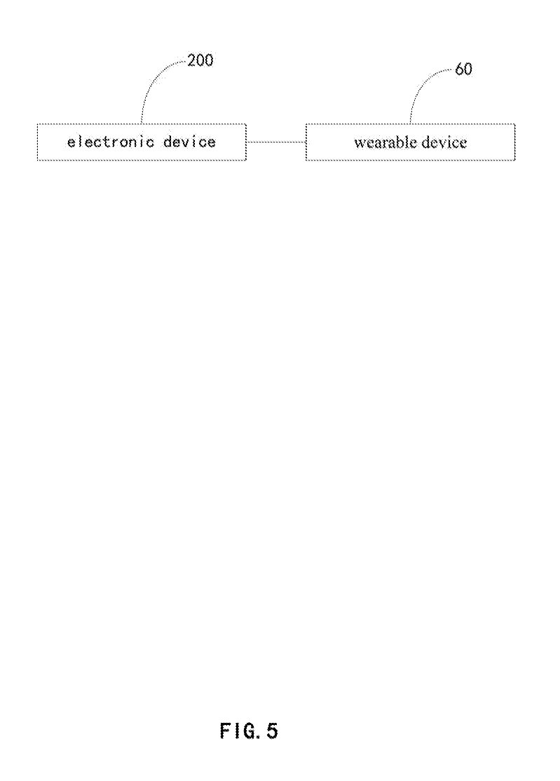

Referring to FIG. 5, an electronic device 200 is illustrated in a second exemplary embodiment. The electronic device 200 can be used with a wearable device 60.

The wearable device 60 can be a Virtual Reality (VR) device, a Mixed Reality (MR) device or an Augmented Reality (AR) device. Each of the VR device, the MR device and the AR device can include a camera and a display.

When the wearable device 60 is a VR device, the moving objects can be shown in a 3D way. When two moving objects contact each other, vibration can be generated by the VR device and be felt by a user. When the wearable device 60 is an MR device or an AR device, moving objects, such as bubbles, can be shown on the display unit 10 when the camera of the MR device or the AR device takes a picture of something of a pre-determined shape. It is understood that an user can chose one of the VR device, the MR device, or the AR device to use with the electronic device 200, or the VR device and the MR device together can be used with the electronic device 200. Augmented reality (AR) is understood to generally occur at one end of an artificial spectrum where the real world environment of a user is supplemented with non-real or manufactured sensations.

Virtual reality (VR) is understood to generally occur at an opposite end of the artificial spectrum where real world environment of a user is replaced with non-real or manufactured sensations.

Mixed reality (MR) is understood to generally occur somewhere between the two ends of the artificial spectrum, where physical and digital objects interact with the real and non-real environment of the user to provide a supplemented and/or supplanted experience.

In at least one exemplary embodiment, when the AR device or the MR device takes a picture of something of a pre-determined shape, the painting unit 21 can be activated to paint a new moving object, such as a bubble.

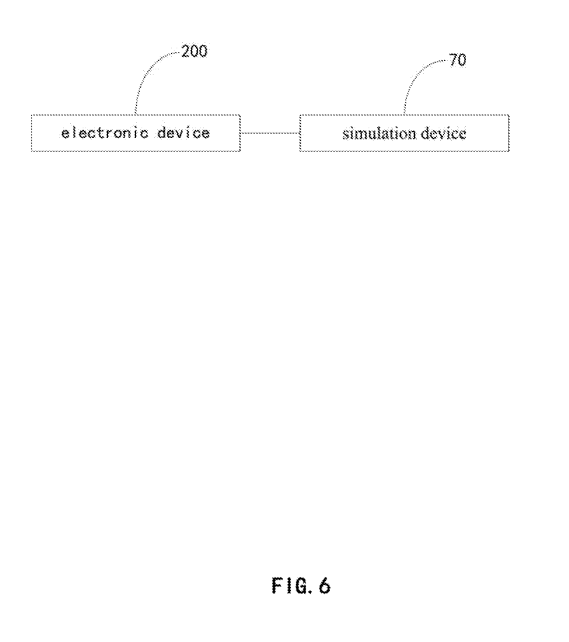

Referring to FIG. 6, an electronic device 200 is illustrated in a third exemplary embodiment. The electronic device 200 can be used with a simulation device 70. The simulation device 70 can be connected to the electronic device 200 through a USB connector or other types of connector.

The simulation device 70 can be an air-blowing device, a smell generating device, a water injecting device, a smog producing device, or a laser device.

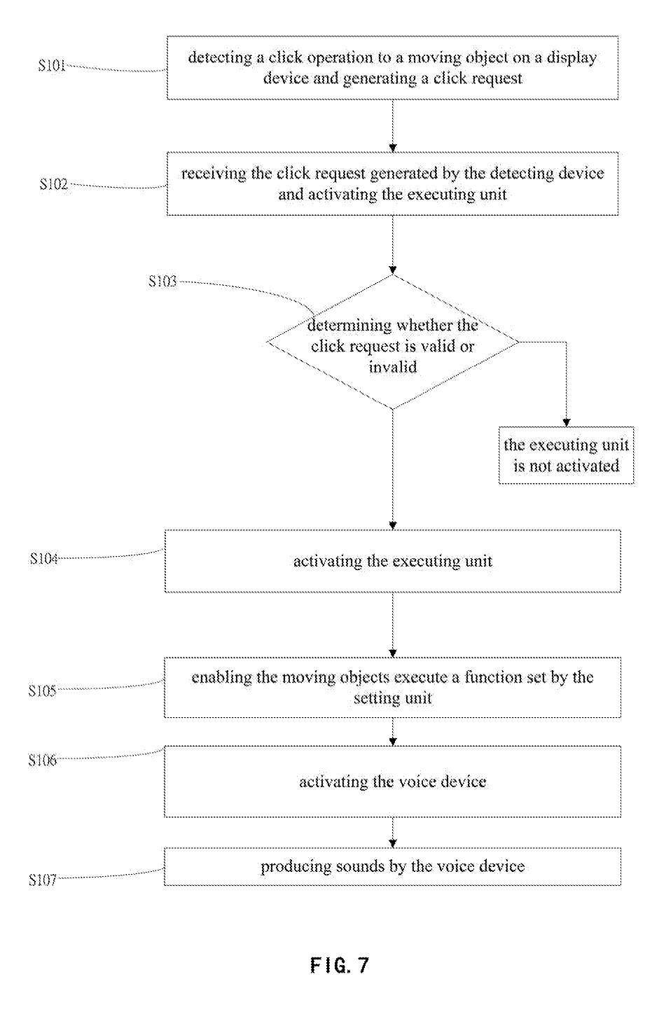

Referring to FIG. 7, a screen saving method implemented by the screen saving system 100 is illustrated in an exemplary embodiment. The screen saving method is implemented when the electronic device 200 is in idle for a pre-determined time, such as 5 minutes. The screen saving method includes following steps.

S101: detecting a click operation to a moving object on a display device and generating a click request. For example, when the electronic device 200 is a tablet computer, a PDA or a mobile phone with a display unit 10, the display unit includes a touch screen 11, when a user click or touch a moving object shown on the touch screen 11, the detecting device 30 detects the click or touch operation and generates a click request.

S102: the receiving unit 24 receives the click request generated by the detecting device 30 and activates the executing unit 26.

S103: the determining unit 25 determines whether the click request is valid or invalid, if the click request is valid, S104 is performed, if the click request is invalid, then S108 is performed. Specifically, the click request can be determined by a click force and a time duration of a click or touch operation. If the click force and the time duration of a click or touch operation is within a predetermined range, the click operation is valid, otherwise the click operation is invalid.

S104: the setting unit 22 activates the executing unit 26.

S105: the executing unit 26 enables the moving objects execute a function set by the setting unit 22. For example, a moving object can be set by the setting unit 22 that when the moving object is clicked, this moving object is broken into pieces.

In at least one exemplary embodiment, the executing unit 26 activates the simulation device 70 when the moving objects are clicked or touched. The simulation device 70 can provide simulated experiences for users.

The screen saving method can further include a step S106: when a moving object is clicked, the voice device 27 is activated by the executing unit 26.

The screen saving method can further include a step S107: a sound is produced by the voice device 27.

S108: the executing unit 26 is not activated.

In at least one exemplary embodiment, when the electronic device 200 is awoke by a mouse or a keyboard, the steps S101-S108 is suspended.

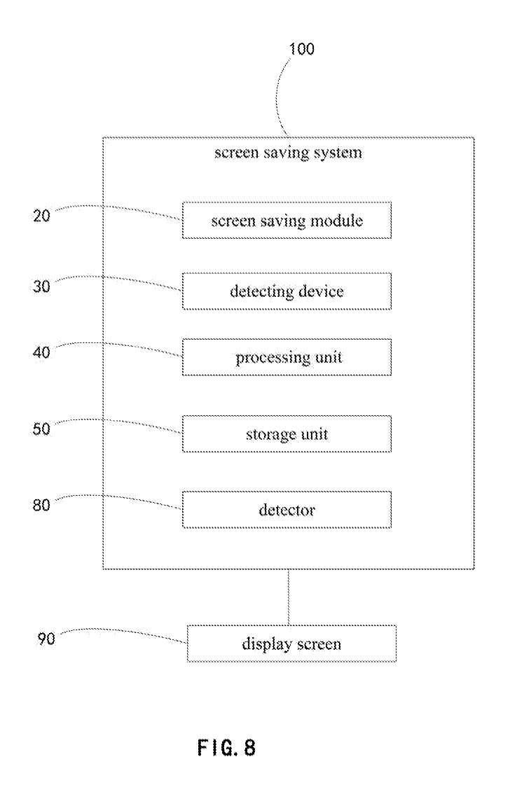

Referring to FIG. 8, an electronic device 200 is illustrated in a fourth exemplary embodiment. The electronic device 200 can be projector and the electronic device further includes a display screen 90, the screen saving system 100 can further include a detector 80. Moving objects can be shown on the display screen 90. The detector 80 can be used to detect a touch or click operation to the moving objects by an user, the detecting device 30 can be used to receive the touch or click operation detected by the detector 80 and generate a click request.

In at least one exemplary embodiment, the moving objects are projected on the display screen 90, the detector 80 detects if there is extrinsic objects, such as hands of a user's, partially covering the display screen 90. For example, when a user touches a moving object shown on the display screen 90 by hands, the detector 80 detects the position of the hands and compares with the position of the moving objects. If the position of the hands overlaps the position of a moving object, this moving object can be identified as a moving object that is been touched, and this moving object executes a function set by the setting unit 22, and a new picture can be produced and shown on the display screen 90 after the function is executed. The detector 80 can be an optical sensor, such as a lidar. The detector 80 can also be a sonic sensor. A detecting direction of the detector 80 is same as the projecting direction of the projector, so that when a moving object projected by the projector to the display screen 90 is touched, the detector 80 can detect this touch operation.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A screen saving method comprising:
detecting a click operation to a moving object on a display device and generating a click request;
receiving the click request;
determining whether the click request is valid or invalid; and
driving the moving object to execute a predetermined function when the click request is valid.

2. The screen saving method of claim 1, wherein the screen saving method further comprises:
activating a voice device to produce a predetermined sound when the moving object executed the predetermined function.

3. The screen saving method of claim 1, wherein the screen saving method further comprises:
generating a new object when the moving object executed the predetermined function.

4. The screen saving method of claim 1, wherein the screen saving method further comprises:
painting the moving object before receiving the click request.

5. The screen saving method of claim 1, wherein the screen saving method further comprises:
driving the moving objects to move randomly.

6. A screen saving system comprising:
a storage unit configured to store instructions; and
a processing unit configured to execute the instructions;
wherein the instructions are executed to:
detecting a click operation to a moving object on a display device and generating a click request;
receiving the click request;
determining whether the click request is valid or invalid; and
driving the moving object to execute a predetermined function when the click request is valid.

7. The screen saving system of claim 6, wherein the instructions are also executed to:
activating a voice device to produce a predetermined sound when the moving object executed the predetermined function.

8. The screen saving system of claim 6, wherein the instructions are also executed to:
generating a new object when the moving object executed the predetermined function.

9. The screen saving method of claim 8, wherein the instructions are also executed to:
painting the moving objet before receiving the click request.

10. The screen saving method of claim 6, wherein the instructions are also executed to:
driving the moving objects to move randomly.

11. An electronic device comprising:
a display unit comprising a touch screen; and
a screen saving system comprising:
a storage unit configured to store instructions; and
a processing unit configured to execute the instructions;
wherein the instructions are executed to:
detecting a click operation to a moving object on a display device and generating a click request;
receiving the click request;
determining whether the click request is valid or invalid; and
driving the moving object to execute a predetermined function when the click request is valid.

12. The electronic device of claim 11, wherein the instructions are also executed to:
activating a voice device to produce a predetermined sound when the moving object executed the predetermined function.

13. The electronic device of claim 12, wherein the instructions are also executed to:
generating a new object when the moving object executed the predetermined function.

14. The electronic device of claim 13, wherein the instructions are also executed to:
painting the moving objet before receiving the click request.

15. The electronic device of claim 11, wherein the instructions are also executed to:
driving the moving objects to move randomly.
